(19) United States
(12) Patent Application Publication
(10) Pub. No.: US 2010/0002984 A1
(43) Pub. Date: Jan. 7, 2010

(54) OPTICAL WAVEGUIDE DEVICE

(75) Inventor: Koki Sato, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: MITSUMI ELECTRIC Co., Ltd., Tama-shi, Tokyo (JP)

(21) Appl. No.: 12/373,719

(22) PCT Filed: Jul. 11, 2007
(86) PCT No.: PCT/JP2007/063816

§ 371 Date: Jan. 13, 2009

(30) Foreign Application Priority Data
Jul. 13, 2006 (JP) 2006-192853

(51) Int. Cl. G02B 6/12

(52) U.S. Cl. 385/14

(57) ABSTRACT

An optical waveguide device having a high impact resistance and which can prevent bending and disconnection of an optical fiber, includes a substrate formed with an optical waveguide; an optical fiber connected to both of end portions of the optical waveguide; and a case housing the substrate and holding the optical fiber through a flexible member. Since the optical fiber is held to the case with the flexible member therebetween, thermal stress caused by a difference of the linear expansion coefficient of the optical fiber and that of the case is absorbed by the flexible member, and bending and disconnection of the optical fiber can be prevented. The optical fiber is locked to the case by a stopper such that a tensile force applied to the optical fiber is not propagated to a connection section between the optical fiber and the optical waveguide, and thus, impact resistance is improved.

### TECHNICAL FIELD

The present invention relates to an optical waveguide device which is connected to an optical cable.

### BACKGROUND ART

In recent years, as data communication speeds up, optical communication using an optical cable has become the mainstream instead of communication by the conventional metallic cable. As an optical waveguide device to perform the optical communication, an optical waveguide device which is optically connected to an optical cable and which splits light that is propagated through the optical cable into a plurality of optical cables, may be used.

For example, as shown in FIGS. 4A and 4B, an optical cable 220 comprises an optical fiber wire 222 therein which is multi-core or single-core, and transmits light guided by an optical fiber wire 62 in an extending direction. An optical waveguide device 200 comprises an optical waveguide section 211, and a connection section 212 to connect the optical waveguide section 211 and the optical fiber wire 62, on a substrate 210. In the optical waveguide section 211, a core 2111 formed with a plurality of Y-shaped branches is covered with a clad 2112, and the core 2111 splits the input light to output the split light (in reverse, the input light may be gathered so that the gathered light is output).

As shown in FIGS. 4A and 4B, the connection section 212 is formed with a groove section 215 on the substrate 210 so that the optical fiber wire 222 can be fitted therein. The connection section 212 has the following configuration: the optical fiber wire 222 which is uncovered at an end portion of the optical cable 220 is fitted along a wall surface of the groove section 215 so as to be positioned (passive alignment); the optical fiber wire 222 is pressed on by a glass block 213 so as to be sandwiched by the pressing surface of the glass block 213 and the wall surface of the groove section 215; the optical fiber wire 222 is bonded and fixed by a bonding member 214; and the optical waveguide in between the optical fiber wire 222 and the core 2111 is connected.

Further, in the Patent Document 1, in the same manner as the configuration described above, the configuration in which an optical fiber is inserted into a groove section so as to perform the positioning of an end surface of the optical fiber and of an optical waveguide such as an optical splitter or the like, and the optical fiber is pressed on by a glass block from above to be bonded and fixed thereon (optical fiber module) is disclosed.

When connecting an optical cable and an optical device such as an optical splitter, a laser-diode (LD), a vertical-cavity surface-emitting laser (VCSEL), a photo-diode (PD), or the like, and when connecting the optical cables with each other, in an optical communication, it is important to perform an accurate alignment and fixing so as not to misalign the connection even when some external force is received, in order to reduce loss at the connecting points. Accordingly, housing the optical fiber module in a package is suggested (see for example, Patent Documents 2 and 3).

### [Patent Document 1] Japanese Patent Application Laid-Open Publication No. 2004-20656

### [Patent Document 2] Description of Japanese Patent No. 3699363

### [Patent Document 3] Japanese Patent Application Laid-Open Publication No. 10-206681

### DISCLOSURE OF THE INVENTION

### Problem to be Solved by the Invention

However, in a case where the optical fiber module is housed in a package, it is necessary to heat the bonding adhesive used for the package in order to perform aging. Thus, the optical fiber may be bent or disconnected because of the difference in coefficient of thermal expansion between the package and the optical fiber.

It is an object of the present invention to provide an optical waveguide device which solves the above described problem, has high impact resistance, and can prevent the bending and disconnection of the optical fiber.

### Means for Solving the Problem

In order to solve the above problem, the invention as claimed in claim 1 is, an optical waveguide device, comprising:

a substrate which is formed with an optical waveguide;

an optical fiber which is connected to both of end portions of the optical waveguide; and

a case to house the substrate and to hold the optical fiber through a flexible member.

The invention as claimed in claim 2 is, the optical waveguide device as claimed in claim 1, wherein the optical fiber comprises a stopper which is to be locked to an inner wall of the case.

The invention as claimed in claim 3 is, the optical waveguide device as claimed in claim 2, wherein the stopper is formed by shrinking a heat shrinking tube by heat, through which the optical fiber is inserted.

The invention as claimed in claim 4 is, the optical waveguide device as claimed in claim 1, comprising a buffer material in between the case and the substrate.

The invention as claimed in claim 5 is, the optical waveguide device as claimed in claim 1, wherein the case comprises a vacuum hole to vacuum up the substrate which is inside of the case by a vacuum chuck from outside.

### EFFECT OF THE INVENTION

According to the present invention, an optical waveguide device which has high impact resistance, and can prevent the bending and disconnection of the optical fiber can be provided.

### BRIEF DESCRIPTION OF THE DRAWINGS

FIG. 1 This is an exploded perspective view showing an optical waveguide device 1.

FIG. 2A This is a cross-sectional view showing an assembling process of the optical waveguide device 1.

FIG. 2B This is a cross-sectional view showing an assembling process of the optical waveguide device 1.

FIG. 2C This is a cross-sectional view showing an assembling process of the optical waveguide device 1.

FIG. 2D This is a cross-sectional view showing an assembling process of the optical waveguide device 1.

FIG. 3A This is a cross-sectional view showing a stopper 63 in a state in which a ribbon fiber 60 is inserted therethrough.

FIG. 3B This is a cross-sectional view showing a stopper 63 in a state in which a ribbon fiber 60 is inserted therethrough.

FIG. 4A This is a perspective view showing an external appearance of the conventional optical waveguide device 200.

FIG. 4B This is a perspective view enlarging a region C of FIG. 4A.

### DESCRIPTION OF REFERENCE NUMERALS

1 optical waveguide device
10 case
23 vacuum hole
40 buffer material
50 optical waveguide chip
51 substrate
52 optical waveguide section (optical waveguide)
53 optical fiber connection section
57 flexible bonding adhesive (flexible member)
60 fiber ribbon (optical fiber)
63 stopper

### BEST MODE FOR CARRYING OUT THE INVENTION

Hereinbelow, a detailed description is given for an embodiment of an optical waveguide device according to the present invention.

[Optical Waveguide Device]

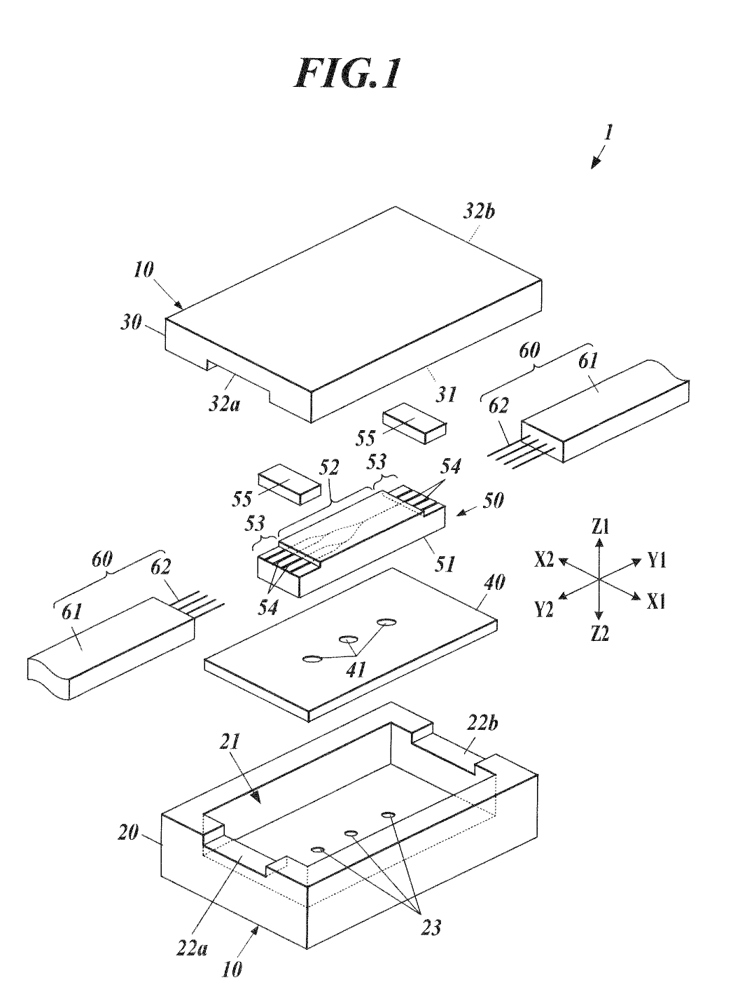

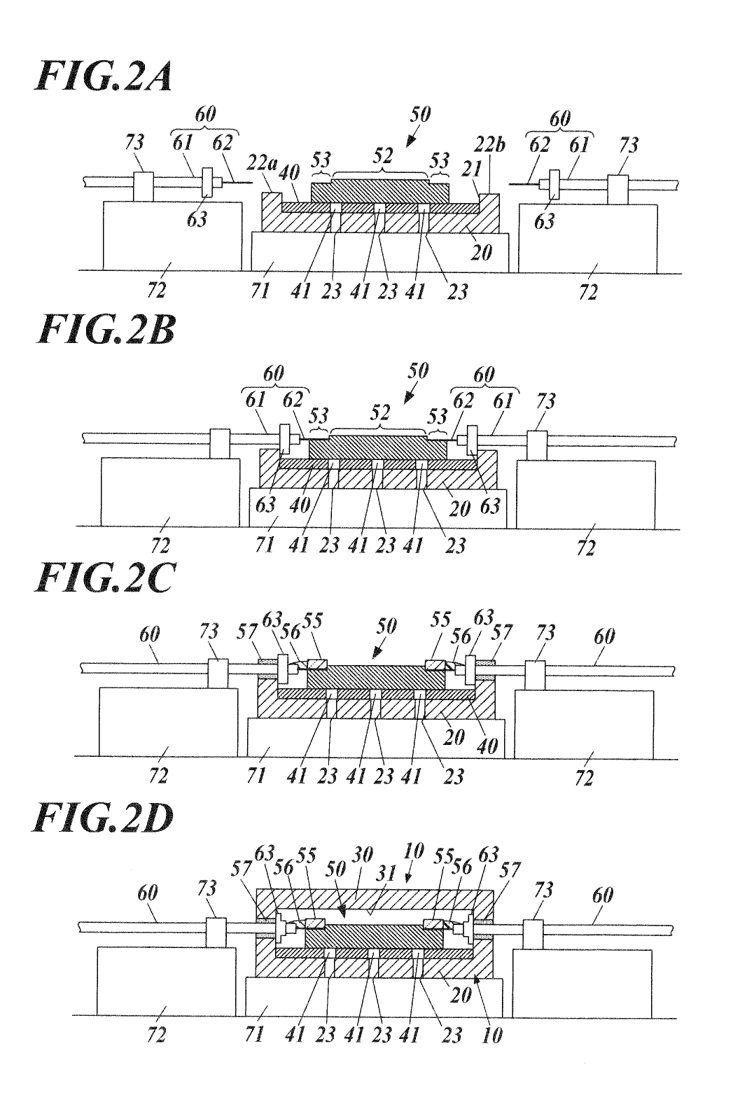

FIG. 1 is an exploded perspective view showing the optical waveguide device 1, and FIG. 2 is a cross-sectional view showing an assembling process of the optical waveguide device 1. The optical waveguide device 1 substantially comprises a case 10, a buffer material 40, an optical waveguide chip 50, a glass block 55, and a ribbon fiber 60.

The case 10 comprises a container body 20 and a lid body 30. As shown in FIG. 1, the container body 20 is formed with a concave section 21 at the upper side to house the buffer material 40, the optical waveguide chip 50, and the like. Further, the container body 20 is cut away in the end portion of the upper edge in the Y1 direction and in the Y2 direction so that inserting sections 22a and 22b are provided. The inserting sections 22a and 22b are arranged so as to oppose inserting sections 32a and 32b of the lid body 30 to each other, which will be described later, and enable the ribbon fiber 60 to be inserted inside when the container body 20 and the lid body 30 are assembled with each other.

Further, vacuum holes 23 are provided in the bottom portion of the container body 20. The vacuum holes 23 are used for sucking the optical waveguide chip 50 which is housed inside of the case 10, by a vacuum chuck of an assembling device, which will be described later.

The lid body 30 is formed with a concave section 31 in the lower surface to house the glass block 55, the optical waveguide chip 50, and the like. Further, the lid body 30 is cut away in the end portion of the lower edge in the Y1 direction and in the Y2 direction so that the inserting sections 32a and 32b are provided.

The upper edge of the container body 20 and the lower edge of the lid body 30 are bonded together by the flexible bonding adhesive. Incidentally, bonding adhesives such as a modified silicon, a high-viscosity soft epoxy, and the like can be used as the flexible bonding adhesive.

The buffer material 40 is laid in the bottom portion of the container body 20, and prevents impact caused by a decent, vibration, and the like acting on the container body 20 from propagating to the optical waveguide chip 50. As the buffer material 40, for example, a sheet material such as ethylene-vinyl acetate (EVA), and the like, or gel formed by polymer, and the like may be used. In the buffer material 40, penetrating holes 41 are provided at positions corresponding to the vacuum holes 23 of the container body 20. The internal diameter of the penetrating holes 41 is larger than that of the vacuum holes 23 of the container body 20, and thus a margin of error of the positioning of the buffer material 40 can be accepted.

The optical waveguide chip 50 comprises an optical waveguide section 52 formed on the substrate 51, and an optical fiber connection section 53 to optically connect the optical fiber wire 62 inside of the ribbon fiber 60 to the optical waveguide section 52.

On the substrate surface of the substrate 51 in the Z1 direction, the optical waveguide section 52 comprises a core formed with a plurality of Y-shaped branches, and a clad which covers the core. The light input from the Y1 direction is split in FIG. 1. Incidentally, in reverse, the light input from the Y2 direction may be gathered.

As shown in FIG. 1, on the substrate surface of the substrate 51 in the Z1 direction, the optical fiber connection section 53 is formed with a groove section 54 in the direction along the light propagating direction of the core. The groove section 54 is formed at a predetermined designed position according to the diameter of the optical fiber wire 62 and the position of the core, so that the optical fiber wire 62 of the ribbon fiber 60 can be fitted therein.

The ribbon fiber 60 which is connected to the optical fiber connection section 53 comprises the optical fiber wire 62 which is multi-core or single-core, inside of a coating 61 of the ribbon fiber 60, and the optical fiber wire 62 is exposed in the end portion region where the optical fiber connection section 53 is connected to the ribbon fiber 60. The optical fiber wire 62 is manufactured by for example, extending a pre-form made by doping germania (GeO₂) and the like to quartz (SiO₂) glass so as to be cylindrical, and in the vicinity of the center thereof, the core is extended in a state of being covered with the clad. Incidentally, the optical fiber wire 62 may be formed from a multi-component glass, a plastic optical fiber (POF), or the like, and the shape thereof is not limited to cylindrical as described above. The ribbon fiber 60 totally reflects the light input from one end side of the optical fiber wire 62 to the core, transmits the totally reflected light, and outputs the totally reflected light to the other end side.

Incidentally, in FIG. 1, the light is transmitted form Y1 side to Y2 side, and the ribbon fiber 60 in the Y1 side comprises four optical fiber wires 62. The light is transmitted to only one of the four optical fiber wires 62, which is connected to the core 521.

A stopper 63 is mounted on the ribbon fiber 60. The stopper 63 is locked on an inner wall of the case 10, and prevents the inserting section of the ribbon fiber 60 to the case 10 from falling off. As the stopper 63, for example, a heat shrinkable tube which shrinks at 90° C. or the like may be used. As the heat shrinkable tube, a polymer product such as polyethylene or the like may be used.

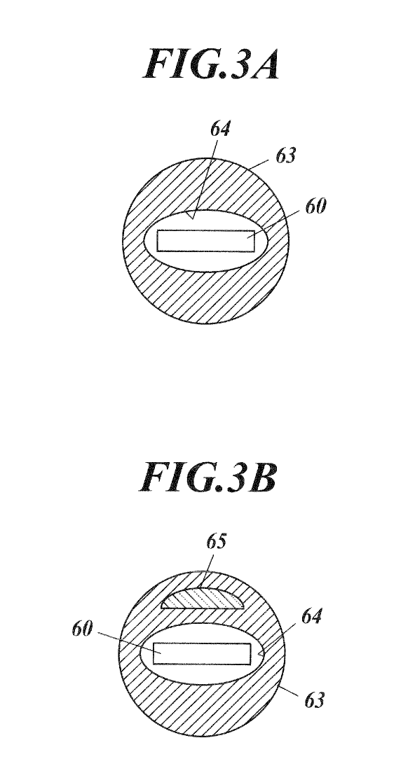

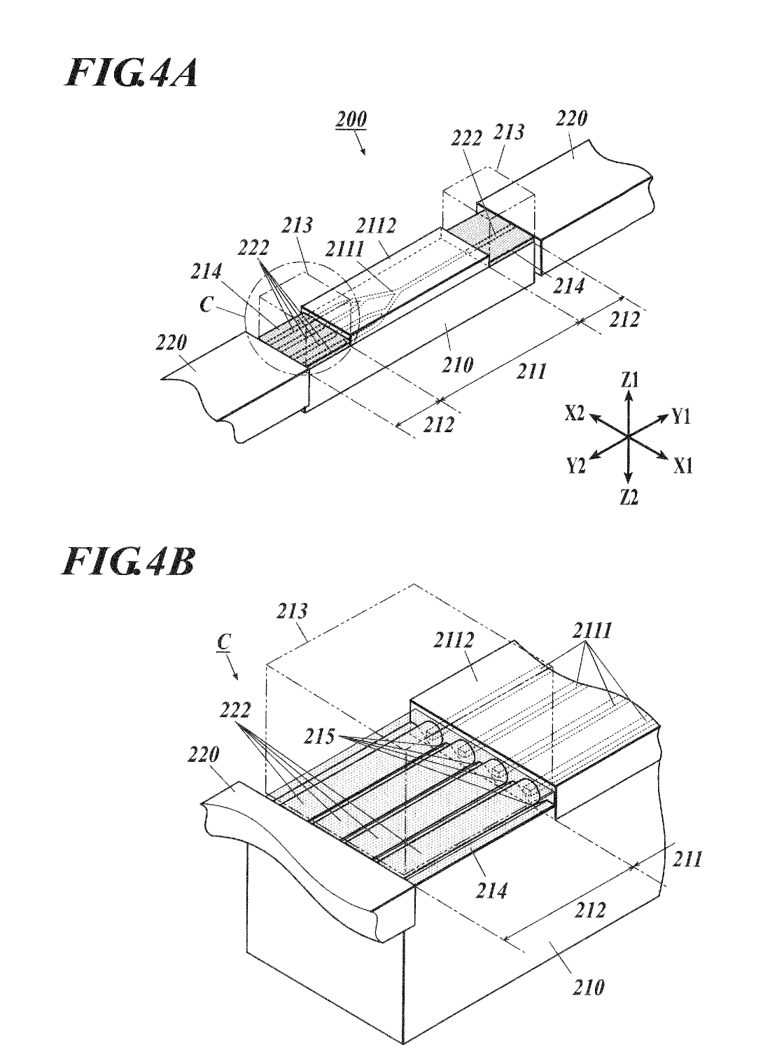

FIG. 3 is a cross-sectional view showing the stopper 63 in a state in which the ribbon fiber 60 is inserted therethrough. For example, as shown in FIG. 3(a), the ribbon fiber 60 is inserted through a hole 64 of the stopper 63. By heating the ribbon fiber 60, the stopper 63 is shrunk, and can be mounted on the ribbon fiber 60. Incidentally, as shown in FIG. 3(b) for example, the stopper can be provided with a reinforcement material 65 such as metal, glass, or the like.

The glass block 55 is bonded to the optical fiber connection section 53 by the bonding adhesive in a state of pressing the end portion of the optical fiber wire 62 which is fitted in the groove section 54. By injecting the bonding adhesive in between the glass block 55 and the optical fiber connection section 53, in a state in which the end portion of the optical fiber wire 62 is fitted in the groove section 54 and is sandwiched in between the glass block 55, the optical fiber wire 62 is fixed on the optical waveguide chip 50.

[Assembling Device]

An assembling device is used in order to assemble the optical waveguide device 1. Here the assembling device of the optical waveguide device 1 is described.

As shown in FIG. 2, the assembling device comprises a YZ stage 71, and two XYθ stages 72, 72.

The YZ stage 71 comprises a mechanical chuck to hold the container body 20, and a vacuum chuck to vacuum up the optical waveguide chip 50 from the vacuum holes 23 of the container body 20, both of which are not shown. The YZ stage 71 holds the container body 20, and moves the container body 20 in the Y-axis direction and in the Z-axis direction.

The XYθ stages 72, 72 respectively comprise fiber holding members 73, 73 to hold the ribbon fiber 60. The XYθ stages 72, 72 move the fiber holding members 73, 73 in the X-axis direction and in the Y-axis direction, and further revolve the fiber holding members 73, 73 around the Z-axis.

[Assembling Process]

Hereinbelow, the assembling process of the optical waveguide device 1 is described. First, as shown in FIG. 2(a), the container body 20 is held by the mechanical chuck of the YZ stage 71. Next, the buffer material 40 is laid on the bottom portion of the container body 20, the optical waveguide chip 50 is placed thereon, and the optical waveguide chip 50 is sucked through the vacuum holes 23 by the vacuum chuck to be fixed thereon.

Next, the ribbon fiber 60 which is inserted through the stopper 63 is held by the fiber holding members 73, 73 of the XYθ stages 72, 72.

Next, as shown in FIG. 2(b), the fiber holding members 73, 73 are moved in the Y-axis direction by the XYθ stages 72, 72, and the ribbon fiber 60 is placed at the inserting sections 22a, 22b of the container body 20. Further, the fiber holding members 73, 73 are slightly moved by the XYθ stages 72, 72, and the optical fiber wire 62 which is exposed from the tip of the ribbon fiber 60 is placed on the groove section 54 of the optical fiber connection section 53 of the optical waveguide chip 50.

Next, the glass block 55 is placed on the optical fiber connection section 53 so that the groove section 54 is pressed by the optical fiber wire 62. In this state, the optical fiber wire 62 is slightly moved by the XYθ stages 72, 72, and the end surface of the optical fiber wire 62 contacts the end surface of the waveguide elemental device, so that the optical axis is adjusted.

Next, the bonding adhesive is permeated in between the optical fiber connection section 53 and the glass block 55, so as to be fixed. Further, resin 56 is supplied in between the optical fiber connection section 53 and the fiber coating 61, so as to be solidified. Thereby, the optical waveguide chip 50 and the optical fiber wire 62 are united with each other.

Next, the stopper 63 through which the ribbon fiber 60 is inserted is placed at the inner side end portion of the container body 20 of the inserting sections 22a, 22b.

Next, the flexible bonding adhesive 57 is supplied at the upper edge portion of the container body 20, which is in between the inserting sections 22a, 22b, 32a, 32b of the container body 20 and of the lid body 30, and the ribbon fiber 60. Thus, the lid body 30 is covered on the container body 20. The state in which the lid body 30 is applied with pressure from above is left for 30 minutes in a room temperature, for example. Thus the flexible bonding adhesive 57 becomes cured (provisionally cured).

Next the ribbon fiber 60 is detached from the fiber holding members 73, 73 of the XYθ stages 72, 72, the vacuuming up by the vacuum chuck is stopped, and the mechanical chuck is released, so that the YZ stage 71 is detached from the container body 20.

Next, the vacuum holes 23 are sealed by the flexible bonding adhesive.

Subsequently, the container body 20 and the ribbon fiber 60 are placed in an oven, and heating processing (for example, leaving them in an air atmosphere of 90 to 100° C. for one hour) is performed. Thereby, the flexible bonding adhesive is aged, and the stopper 63 is shrunk by heat so as to be fixed onto the ribbon fiber 60.

Subsequently, the container body 20 and the ribbon fiber 60 are removed from the oven to be cooled down. As described above, the optical waveguide device 1 is completed.

In this manner, by sequentially performing the connecting process of the optical waveguide chip 50 and the ribbon fiber 60, and the packaging process for the case 10, the time necessary for the processing can be shortened, and the manufacturing cost can be reduced.

In the optical waveguide device 1 which is assembled by the above described process, the ribbon fiber 60 is fixed to the container body 20 and to the lid body 30 by the flexible bonding adhesive 57. Thus, the thermal stress caused by the difference in the coefficient of linear thermal expansion between the optical waveguide chip 50 and the ribbon fiber 60, and that between the container body 20 and the lid body 30, can be absorbed by the flexible bonding adhesive 57. Thereby, the bending and the disconnection of the optical fiber wire 62 can be prevented.

Moreover, the ribbon fiber 60 is locked to the container body 20 and to the lid body 30 by the stopper 63, and force is not propagated to the connection section of the optical fiber wire 62 and the optical waveguide chip 50, even in a case where a tensile force is applied to the ribbon fiber 60. Thus, the impact resistance can be increased.

A high-temperature and high-humidity test of 85° C., relative humidity of 85%, and 2000 hours was performed by using the above described optical waveguide device 1. Thus, it was verified that the loss increase converges in less than 0.5 dB.

Incidentally, the above described optical waveguide device 1 can be applied to a splitter of optical communicating device, a wavelength multiplexer demultiplexer, a switch, and the like, but the application of the optical waveguide device 1 is not limited to these, and the optical waveguide device 1 can be applied to various products which mount the optical fiber.

1. An optical waveguide device, comprising:
a substrate which is formed with an optical waveguide;
an optical fiber which is connected to both of end portions of the optical waveguide; and
a case to house the substrate and to hold the optical fiber through a flexible member.

2. The optical waveguide device as claimed in claim 1, wherein the optical fiber comprises a stopper which is to be locked to an inner wall of the case.

3. The optical waveguide device as claimed in claim 2, wherein the stopper is formed by shrinking a heat shrinking tube by heat, through which the optical fiber is inserted.

4. The optical waveguide device as claimed in claim 1, comprising a buffer material in between the case and the substrate.

5. The optical waveguide device as claimed in claim 1, wherein the case comprises a vacuum hole to vacuum up the substrate which is inside of the case by a vacuum chuck from outside.
